(19) United States
(12) Patent Application Publication
(10) Pub. No.: US 2006/0150803 A1
(43) Pub. Date: Jul. 13, 2006

(54) System and method for music score capture and synthesized audio performance with synchronized presentation

(76) Inventor: Robert Taub, Princeton, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/303,812

(22) Filed: Dec. 15, 2005

Related U.S. Application Data
(60) Provisional application No. 60/636,465, filed on Dec. 15, 2004.

(51) Int. Cl. G10H 7/00

(52) U.S. Cl. 84/616

(57) ABSTRACT

A music score is interpreted and processed and a synthesized performance of the music score is generated along with a visual display of the musical score. The music score can be received by an image capture process or by electronic file transfer. A user's musical performance of the musical score can be recorded for later playback and comparison (simultaneous comparison, if desired) with the synthesized version. The features can be provided via application software installed on a digital computer such as a desktop computer or can be provided in a handheld device. Music score data can be received from an external source such that the computing device can produce an audio presentation of the music score data and can produce a synchronized visual presentation of the music score. The user can delete any musical part or combination of parts in a multi-part musical piece so that the user can play “duets” with the device.

### REFERENCE TO PRIORITY DOCUMENT

This application claims the benefit of priority of co-pending U.S. Provisional Patent Application Ser. No. 60/636,465 entitled “Sheet Music Synthesized Performance, Presentation, and Playback System and Method”, by Robert Taub filed Dec. 15, 2004. Priority of the filing date of Dec. 15, 2004 is hereby claimed, and the disclosure of the Provisional Patent Application is hereby incorporated by reference.

### BACKGROUND

Persons who wish to improve their playing of a musical instrument have traditionally relied on personal instruction and solitary practice sessions. While personal instruction can be very helpful, it is typically rather expensive and is dependent on the availability of a personal instructor to fit the schedule of the music student. Solitary practice sessions are convenient, but lack useful immediate feedback on the performance of the student performer.

A variety of devices can help performers improve their musical instrument playback performance. For example, electronic metronomes help a performer maintain a steady count. Systems have been developed for computer display of a music score (sheet music), making a wide variety of music conveniently available for practice by the performer. See, for example, U.S. Patent Application 2004/0040433 to M. Errico. Other systems assist in optical recognition of music scores for storage as digital data and subsequent computer display. See, for example, U.S. Pat. No. 5,825,905 to T. Kikuchi.

It would be helpful if a performer could utilize a synthesized performance (audio rendition) of a music score and could listen at any time to difficult passages in a music score (or in fact, listen to the entire score) played correctly, with the correct pitches (in tune) and the correct rhythms. The performer could then practice by duplicating or reproducing the correct ways of playing. It also would be helpful if a performer could view a music score on a dynamic display that is synchronized with the synthesized audio rendition, and practice playing a musical instrument or singing according to the displayed musical score. It would also be helpful if a performer could record his or her performance and then play back the performance at any time, for assessment of the performance and for comparison with the correct (synthesized) rendition. In this way, anyone wishing to practice playing a musical instrument (or voice) could be prompted with a correct musical synthesized rendition and could then evaluate his or her own performance of the music score. In addition, it would be helpful if a performer could play (or sing) along with a correct synthesized rendition.

Thus, there is a need for more convenient music score capture, performance recording, and synthesized performance and analysis techniques. The present invention satisfies this need.

### SUMMARY

The present invention provides capture and subsequent interpretation of a passage of music score (or an entire piece of music or a song) for solo instrument, multiple instruments, voice or multiple voices, or any combination thereof, processing of the data so as to produce a synthesized audio presentation and synchronized concomitant display of a visual presentation of the music score corresponding to the audio presentation, and supports recording of a performer's musical performance of that music score for later playback of the performer's musical performance. The means for providing these features can comprise application software on a host digital computer. Alternatively, these features can be provided by a handheld device that is self-contained. Both embodiments, the host computer and handheld device, include means for receiving a digital representation of the music score, a display that shows a visual presentation of the music score, and a facility for a synchronized synthesized audio rendition of the score. The digital representation of the music score can be received from a digital image capture device or over a network connection from a data source. The embodiments also can provide for recording of a user performance and playback of the user's performance. In accordance with the invention, music score data can be received from an external source such that the computing device can produce an audio presentation of the music score data and can produce a synchronized visual presentation of music notes corresponding to the audio presentation.

Other embodiments can provide additional flexibility and more convenient operation. For example, the handheld device can be adapted to receive external memory cards that can store entire musical works, volumes of works, method books, and the like in digital data format. Internet and/or telecom interfaces can allow for downloads in digital data format. For example, the device can download music scores in digital data format. Such downloads can be stored in external memory cards or similar media. Image capture of input music score data can be supported through digital photography or optical scanning of music scores. The application software implementation can include performance evaluation features and playback assistance features.

A “music minus one” feature can be provided to enable the user to digitally capture a music score that is for more than one instrument or for more than one vocal line (or any combination thereof); opt to have the synthesized audio presentation leave out a specified instrumental or vocal line of the music score (“minus one”) so that the user may play and/or sing along with the synthesized audio presentation. The synchronized visual presentation of the music score can include any or all of the instrumental and/or vocal parts of the original data. The user may opt to leave out more than one part of the synthesized audio presentation, such as additional instruments or vocal lines, resulting in “music minus two” or “music minus three”, and so forth, depending on the number of elements left out.

Other features and advantages of the present invention should be apparent from the following description of the preferred embodiments, which illustrate, by way of example, the principles of the invention.

### BRIEF DESCRIPTION OF THE DRAWINGS

FIG. 1 is an illustration of a hand-held device constructed in accordance with an embodiment of the invention.

FIG. 2 is an illustration of the processing that is performed by a device constructed in accordance with an “eMuse1” embodiment of the invention.

FIG. 3 is an illustration of the processing that is performed by a device constructed in accordance with an “eMuse2” embodiment of the invention.

FIG. 4 is an illustration of the processing that is performed by a device constructed in accordance with an “eMuseX” embodiment of the invention.

FIG. 5 is an illustration of a display screen produced in accordance with the invention for playback of a synthesized audio rendition in accordance with the invention.

FIG. 6 is an illustration of the processing that is performed by a device constructed in accordance with the invention to provide a “music dictation” feature.

FIG. 7 is a block diagram of an embodiment of a music score capture and interpretation device with audio-visual presentation, constructed in accordance with the invention.

### DETAILED DESCRIPTION

In one embodiment, the features of the invention are implemented in software, comprising an application that can be installed on a digital computer. The software implementation preferably provides input and output interfaces for the performer. That is, the host computer in which the software is installed typically includes a display for producing a visual presentation of a music score that the performer can read, to sing along or play the performer's musical instrument. The computer also typically includes an input interface, such as a microphone, for recording the performer's session, and includes an output interface, such as speakers, to enable the performer to listen to the recorded performance. The computer implementation can include image capture, wherein a music score comprising notes on a staff can be digitized via an optical input means and then entered into the computer. The digitized music score can be interpreted via OCR techniques, with the resulting interpreted data being processed so as to produce a synthesized audio rendition of the music score, including when appropriate a synthesized vocal rendition matching words with appropriate pitch, such that the audio rendition is synchronized with a visual presentation of the score. In the additional detailed descriptions provided below, the computer software implementation is referred to as a “Level X” implementation or is referred to as the “eMuse X” product (the name “eMuse” referring to a product embodiment from Princeton Music Labs LLC of Princeton, N.J., USA, the assignee of all rights in the invention).

In another embodiment, the features of the invention are embodied in a handheld device that can include a display, an input interface, audio and visual output interfaces, and OCR image interpretation interfaces. The handheld device implementation includes a variety of convenient user control knobs and mechanisms for convenient navigation of the device functions. The display supports a visual presentation of menu options for selection of functions by the user.

As described further below, a computing device interprets and processes music score data by receiving the music score data from an external source and subsequently producing a synthesized audio rendition of the music score data and a synchronized visual presentation of music score.

The external source can consist of a network data source that provides the music score data to the computing device over a network connection. The network connection can consist of communication between the computing device and the network over a wireless connection.

The music score data can be read from a recorded medium by accepting the recorded medium into a reader of the computing device that then obtains the music score data from the recorded medium. The recorded medium contains sufficient data for synthesized audio rendition in accordance with a musical instrument digital interface (MIDI) specification for synthesized music production. That is, the computing device can receive data that specifies a music score and can generate or synthesize corresponding musical tones in a selected tempo, timbre, clef, key signature, time signature, and the like. The recorded medium can comprise a flash memory device.

The computing device can be provided with ability for recording a user performance of a music score and providing playback of the recorded user performance. The user performance playback can occur independently of the synthesized music score rendition, or can occur simultaneously. In addition, the user performance playback can be provided along with a visual representation of the musical notes corresponding to the recorded user performance. In this way, a “music dictation” feature is provided.

In one alternative, the music score data used by the device to generate both the synthesized audio rendition and the synchronized visual presentation of the music score can be obtained by the device optically capturing a digital image of a music score, then interpreting and processing the digital information to produce a collection of data representing appropriate music notes, thus generating data that corresponds to the musical score.

In addition, musical contextual information can be provided that determines characteristics of the synthesized audio rendition of the music score data, all of which may be adjusted by the user. Such musical contextual information can include multiple key signatures, time signatures timbre, tempo and expressive terms such as legato, crescendo, ritard, etc.

In another alternative, producing an audio playback of the music score data and a visual presentation of musical notes is effected through communication with a network data source. If desired, the network data source provides the music score data to the computing device. In yet another alternative, the network data source can provide to the computing device the musical contextual information that determines musical characteristics of the synthesized audio rendition of the music score data. Also, the network data source can provide the musical context information over a wireless connection.

In one alternative, producing a synthesized audio rendition of the music score data and a synchronized visual presentation of music score is effected by inserting a recorded medium into a reader of the computing device. If desired, the computing device obtains the music score data from the recorded medium, and the recorded medium can also provide the musical contextual information to the computing device for determining musical characteristics of the synthesized audio rendition of the music score data.

One optional feature is to provide recording of the user's instrumental and/or vocal performance of the music score. Another alternative is to produce a synthesized audio rendition in accordance with a musical instrument digital interface (MIDI) specification. In addition, producing the visual presentation can consist of displaying the music score synchronized with the corresponding synthesized audio rendition. Another option is to provide simultaneous synchronized playback, playback of both the visual presentation and audio rendition of the music score data and both the audio component of the recorded user performance and a synchronized corresponding visual display of the music score generated by the user performance.

In accordance with the invention, a computing device can optically digitally capture a music score and interpret the digital image, generating music score data for the computing device that corresponds to the digitally captured music score, and produce a synthesized audio rendition of the music score data and a synchronized visual presentation of music score. The computing device can receive musical contextual information that is used by the computing device to determine musical characteristics of the synthesized audio rendition of the music score data. Similarly to the alternative embodiment described above, the musical contextual information can include multiple key signatures, time signatures timbre, tempo and expressive terms such as legato, crescendo, ritard, etc. that can be selected by the user to determine the musical characteristics of the synthesized audio rendition of the music score data. As an option, the computing device identifies the musical contextual information from the optically digitally captured music score, and optionally can obtain the musical contextual information from a network data source. If desired, the network data source provides the musical contextual information over a wireless connection with the computing device.

The computing device can be provided with its own loudspeakers for audio playback of synthesized renditions and/or performances recorded by the user. Additionally, the device can include an output jack for connection to headphones or external loudspeakers or the like, and can also be provided with wireless transmission capability that allows the device to transmit an audio performance to a wireless sound playback system (such as a home stereo system that has been enabled with wireless components). The device has sufficient computing memory to enable it to store musical passages of predetermined length.

The additional detailed descriptions below refer to various implementations of features in the handheld device implementation and are referred to as “Level 1” and “Level 2” or “eMuse 1” and “eMuse 2”, respectively.

The following discussion describes music playback software that can be installed on a range of digital computing devices, and also describes embodiments of a handheld sheet music reading device, herein collectively referred to as the eMuse product. References to “Company” are references to an entity that provides data or other support for proper operation of the eMuse product. References to “PML” are references to “Company”, Princeton Music Labs, LLC (the assignee of all rights in the invention), or other suitable support entity.

### DESCRIPTION OF PRODUCT EMBODIMENTS

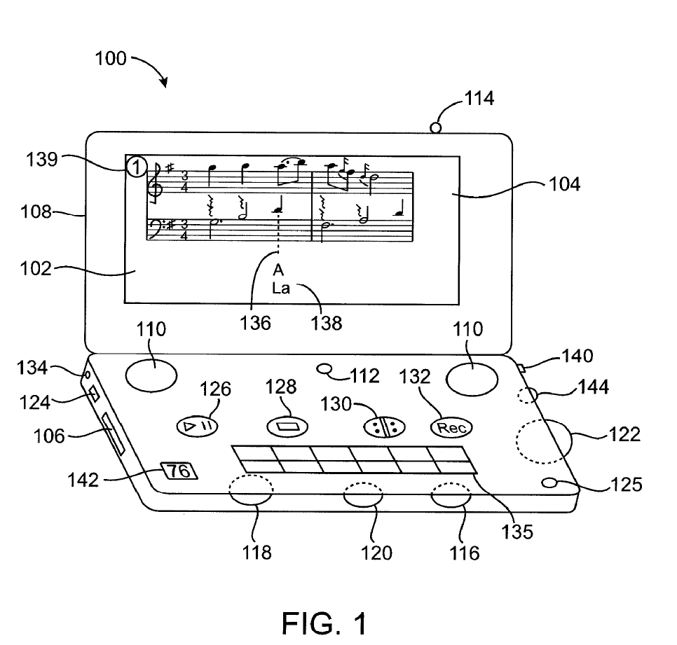

Attached as FIG. 1 is an illustration of a handheld device that provides the functionality and features described herein.

FIG. 1 shows the eMuse product 100 as a hand-held, battery powered “point and shoot” consumer electronic device that captures an image of a selected musical passage—either a few measures or even an entire page—from sheet music, formats and encodes the passage digitally, then plays the selected passage, all virtually instantaneously in real time. The playback sound is instrument-specific, playing in a timbre (i.e., the sound of a piano, violin, flute, etc.) selected by the user. Multiple timbres can be played simultaneously. The device 100 is designed to recognize musical variables, such as key signature, meter, volume, and tempo, and account for musical prose terms, such as forte, piano, cress., legato, and the like. An LCD screen 102 displays the musical passage 104 as the device is playing it back, with each played note highlighted in a unique color so as to distinguish it from the rest of the music score.

The FIG. 1 device 100 incorporates a digital “music card” feature, which supports insertion of a data card (not illustrated) that is encoded with one or more musical pieces, prerecorded or downloaded from the Company's website, and allows for quick reference to specific measures. The data card can comprise recordable media such as typically used by cellular telephones and digital cameras. The data card is received into a card slot 106 of the device 100. The device 100 also works with digital data representing encoded musical pieces. The encoded musical pieces also can be downloaded from the Company's website. Downloaded files can also be saved within memory of the device. The encoded musical pieces provide an enriched listening experience, allowing for quick reference to specific measures of the music score.

A record/playback feature of the device 100 allows the user to immediately evaluate a recorded performance with reference to the music score. That is, the device 100 can record a user's performance of the musical piece and play back the user's performance, along with (or simultaneous with) playback of the received musical piece. The user performance playback can be presented with a corresponding visual presentation, providing the “music dictation” feature described further in this document. Both a metronome and a musical tone tuner capability are also incorporated into the device, and the device can be adjusted for “music minus one.” In a multi-staff or multi-part piece of music, the “music minus one” feature allows the user to determine which part(s) of the piece will be played back by the MIDI interface. This allows the user to play/sing a specific part along with the device.

FIG. 1 shows the device 100 as a hand-held device with a flip-top 108 having the LCD display screen 102 incorporated in the underside of the lid or top 108. The device also incorporates a speaker 110 for music playback (a stereo pair are illustrated in FIG. 1) and a microphone 112 for recording a user performance. Image capture capability can be implemented as shown in FIG. 1, wherein the flip-top 108 includes a camera system comprising an optical lens mounted in the outside surface of the flip-top 108 and triggered by a lens shutter button 114 for purposes of image capture. Various user interface controls are provided, shown as thumbwheels for adjusting volume 116, playback tempo 118, menu navigation 120, and position 122. The device 100 can be provided with a USB port 124, for more easily connecting with a network or other devices. An on/off switch 125 turns the device 100 on and off.

Control buttons are also provided for controlling, as illustrated in FIG. 1, functions involving renditions of the music score (synthesized performance) and playback of the user's performance. FIG. 1 shows exemplary control buttons for the functions of play/pause 126, stop 128, next/reset 130, and record 132. FIG. 1 also shows a metronome readout display 134 that shows a timing indicator and is correlated with the tempo wheel 118. Selection of the metronome function, and the other features of the device 100, is accomplished with menu navigation of the display 102 in conjunction with operation of the menu wheel 120 and/or the position wheel 122. Selection can be achieved through operation of the next/reset control button 130. A keyboard or keypad 135 can be used for input via dedicated function keys of the keypad or alphanumeric input from the keypad. On the display screen 102, graphical images of music notes from the music score 104 are provided, moving across the screen, with individual notes appearing on-screen or being highlighted in the display as the notes are played. The display preferably provides a music staff image that is extended during playback so a predetermined number of notes or measures of music are displayed as the music score is played.

The features of the product can be summarized as follows:
A hand-held, portable “point and shoot” device that “reads” a musical score and plays it back. The playback sound is instrument-specific; the device has adjustable timbre (i.e., the sound of a piano, violin, flute, etc.). It is able to recognize and incorporate additional musical variables, such as key signature, meter, volume, and tempo. Ideally it is also able to recognize and account for musical prose terms, such as forte, piano, crescendo, legato, etc. An LCD monitor with cursor displays the musical passage as the device is playing it back.
A record/playback feature allows the user immediately to evaluate a performance with reference to the musical score. Both a metronome and a tuner are also included.
A “music-card” feature supports insertion of a card encoded with an entire musical piece allows for quick reference to specific measures.
The software embedded in the eMuse device differs from other currently available products in that eMuse receives digitized image data for a music score and interprets that data into corresponding musical notes, and does so with an accuracy rate approaching 100%. Other conventional software products are designed for use by music editors and/or composers using desktop PCs, and expect the user to manually correct scanning and OCR errors in identification of musical notes. Thus, eMuse as a hand-held, untethered, portable device, is designed for use by all music performers, and in such use it is anticipated that there will be no errors to correct.

Functional Description:

“Reading” the Musical Score

A digital camera system 114 captures an image of a passage (a single note, several measures, or even an entire page) within a musical score. The digital camera can be built into the device 100 and can comprise a lens and image transducer combination that will be familiar to those skilled in the art. The LCD display 102 allows the user to determine exactly which measures are captured. The device can read a single stave musical line, duets, trios, quartets, or even a full conductor's score. The device 100 offers multiple simultaneous timbres.

Processing the Music and Downloading Contextual Information

The OCR module receives the “photograph” of the musical excerpt, comprising digitzed image data. Important additional musical contextual information, such as key signature and meter, is also sent to the OCR module, via a music score digital image or via a “cheat sheet” (downloaded from the PML website, then transmitted wirelessly or via the USB port to the device—see below) that lists all available key signatures and time signatures. The “cheat sheet” also includes a section from which the user can select the desired timbre(s), or the user can manually specify (input) the desired timbre(s).

MIDI Synthesizer

The OCR module sends the sound information to the MIDI module that produces synthesized sound. This offers adjustable timbre; the user specifies the type of instrument (piano, violin, flute, etc.) for the particular musical passage or piece. The module also offers adjustable tempo so that the user can hear the passage slower (or faster) than the metronomic (if any) indicated in the score without any alteration of pitch. The device plays back through its own small loudspeaker, and also has a headphone jack 134 and wireless capability for headphones and/or external speakers.

Visual Display

The LCD monitor display 102 helps the user make sure that the measures being captured (photographed) are the measures that are intended to be heard. The LCD monitor display, complete with a cursor 136, displays the music score 104 as the passage is played back, either from a passage that was photographed by the user or from a music-card with stored data. The cursor indicates the exact musical position in the score of the current note(s) being played as the passage is played in real time, regardless of the specified tempo. Rather than a traditional type of moving cursor, the display 102 can instead indicate the note being played by highlighting the note (e.g., making it brighter) or by giving it a different display color from the other notes as it is played. Another option is for the LCD display to show the names of the notes (both in English and in solfege) 138, particularly for a single-line passage. If the passage is comprised of multiple simultaneous musical lines, the user can specify the line for which the names of notes are displayed.

The display 102 also shows an indicator of the music score passage selected for play. The indicator is referred to as the passage marker 139. In FIG. 1, the passage marker 139 is shown as numeral “1” enclosed in a circle. The numerical “1” indicates the first measure of the music score is currently being displayed, and the circle indicates that playback was initiated at the first measure. If playback continues to the next measure, a “2” would be displayed in place of the “1”, but the “2” would not be circled.

Recording Sensor

The microphone 112 is provided so that the user can record him/herself playing (and/or singing) the musical passage in question and immediately play back the recording to compare the user's performance with that of the device 100 (that is, of a previously recorded or synthesized rendition). This feature is helpful for students to make adjustments in notes, tuning, rhythm, and dynamics. As noted above, a user performance can be recorded via the microphone to provide the “music dictation” feature.

Wireless

The device 100 is preferably provided in wireless versions to permit wireless communications with networks and other wireless-enabled device, and to permit downloads of encoded music files with contextual information. The features described herein can be provided by eMuse software installed to a wireless platform, such as a PDA or smartphone, for portable music interaction. In addition, wireless eMuse devices can use computing and memory (and playback audio) of the home PC and/or stereo system.

Power

Power is via rechargeable batteries; DC input ( 9/12 volts) is also available through an external connection 140.

“Music-Card” Feature

A card (information storage device) digitally encoded with an entire musical piece (or a simple method book) can be inserted into the OCR module at the card slot 106. This allows the user quick reference (auditory and visual—see Visual Display above) to specific measures.

“Music-Cards”

These will be available for retail purchase and can comprise conventional media, such as Secure Digital (SD) cards, or CompactFlash cards, or XD cards, or “Memory Stick” devices such as available from Sony Corporation. In addition, PML will offer a substantial library of music (computer file representations of scores, both visual and aural), ranging from method books to more complex standard Classical repertory to jazz and pop “hits”, available for password encrypted downloading for eMuse users. These files will be downloadable to the user's home PC, with the user then either burning a “music-card” or transmitting the file to the wireless eMuse.

Network Communications

The eMuse devices can communicate over telecom networks to download encoded music files from music retailers (such as Tower, HMV, etc.) and ring tone providers.

“Music Dictation”

In another embodiment, a user's performance can be recorded by the device and the user's performance can be subjected to a music note interpretation processing to generate data from which is produced a display of the music notes corresponding to the user's recorded performance. In this way, the device can take “musical dictation” and can convert a live audio performance by the user into a visual display of the music score corresponding to the performance. Thus, the music interpretation features of the device can process both music score data received by optical or electronic network communication, and can process music score data produced by a user's live performance, captured by a microphone.

Product Versions—eMuse1, eMuse2, eMuseX

The embodiments illustrated herein include the following three products:
eMuse1 is a flip-top handheld unit with intuitive controls designed for ease of use. It incoporates an integrated camera and LCD display screen; as the user points the device at a music score, the image of the score is displayed on the LCD display; the user can capture all or a selected portion of score in the device memory by clicking a control button. The proprietary eMuse software interprets the captured image, including the musical contextual information, and produces a synthesized audio rendition of the score. As the music plays, a synchronized visual representation of the score appears on the display screen, and the notes being played at any time are highlighted in color. Controls on the device enable the user to adjust tempo, key signature, etc., or to delete one or more parts (for “music minus one” use). The device has the capability to connect to external sound systems for improved audio quality. eMuse1 also incorporates recording and playback capability (including the music dictation feature) so that the users can record their performance of the work and compare this performance with the original.
eMuse2 incorporates all of the features and functionality of eMuse1, with the addition of an integrated music card reader. Music cards will be available in two forms, pre-encoded with music score data, including musical contextual information, or in blank form. Using a blank music card, the user can download music score data from Internet web sites (either PML's own web site or those of third parties that have licensed the eMuse software) and “burn” the data onto the music card. An optional external music card reader and appropriate interface can be provided with other embodiments (such as eMuse1 and eMuseX) for use of music cards.
eMuseX, which is is designed for home or studio use, is a software product that enables a personal computer to perform the same functions as the handheld eMuse device 100. A scanner or high-resolution webcam attached to the computer captures a digitial image of a music score, and this image is projected onto the user's computer display screen. The user then selects a portion of the score and the synthesized audio rendition of the selected portion is played through speakers attached to the computer. The user will also be able to download music score data to the hard drive of the computer, or purchase pre-encoded music cards, which are read by a media reader connected to the computer's USB port.

The software described herein can be used in a variety of platforms. For example, aspects of eMuse could be embedded in a high-end cell phone in which the cell-phone camera photographs a specific passage in a musical score. The captured image is then compressed and sent to a remote server, which performs OCR operations on the image data to interpret the image into corresponding musical note information. The server then sends back both a midi file and a graphic file, enabling this version of eMuse to play the music that was photographed and display the notes on the LCD as they are played.

Thus, eMuse software can be installed in a user's platform of choice—such as a camera-equipped telephone or similar PDA, in addition to the devices preloaded with eMuse software.

The software that interprets the captured music score image into a corresponding set of notes, utilizes machine learning techniques and will be trained to achieve an accuracy rate approaching 100%, while interpreting substantially in real time. The conventionally available musical notation OCR software for converting musical note images into corresponding notes are generally intended for offline editing, at a time reomved from the actual image capture, and cannot achieve the near-100% accuracies. Currently available music score conversion software can be procured from companies such as Sibelius®, Smart-Score®, and SharpEye®.

In all embodiments described herein, eMuse encoded contextual files can be received over a telecommunications link, either wired or wireless, such as WiFi, Bluetooth® and/or other telecom connections.

eMuse1

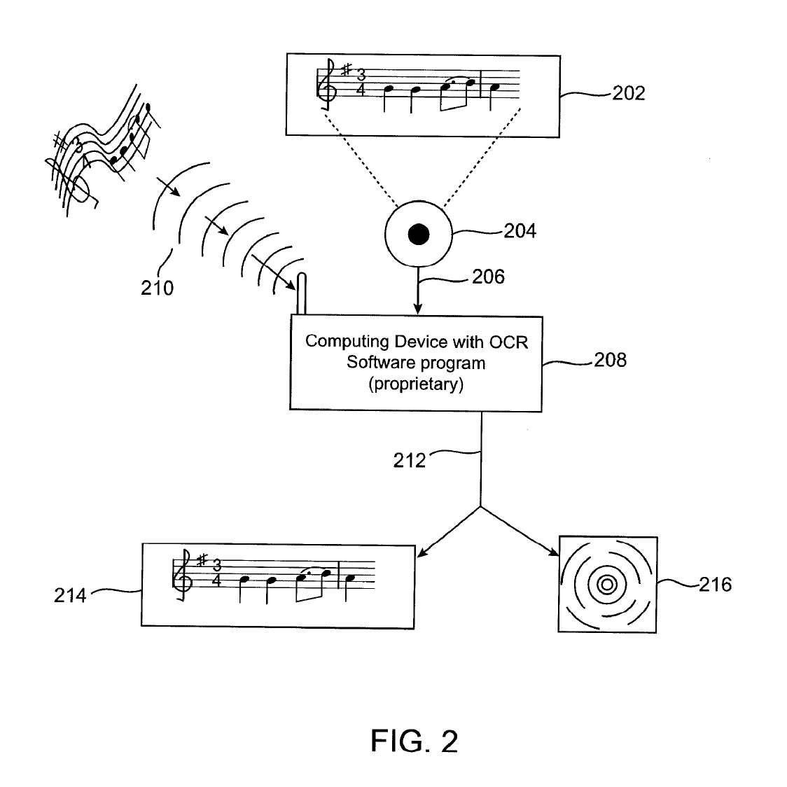

FIG. 2 is a process flow diagram that illustrates operation of the eMuse1 embodiment. In an initial operation, a digital representation of a music score is provided to the eMuse1 device. The digital representation can be received by a visual presentation 202 to the eMuse1 device, such as a printed page, which is digitally captured using a digital image capture device 204, such as a digital camera that operates with the eMuse1 device. The digital data derived from optical input 206 is then provided to a note data interpretation process 208. Alternatively, the digital representation of the music score can be provided electronically 210, such as by wireless transmission of digital data corresponding to the music score or wired transmission of the data over a network, or input through a storage media such as a memory card or other media. The electronically received version of the music score 210 is then provided to the note data interpretation process 208.

The note data interpretation process 208 receives the digital data corresponding to the music score and processes it to produce a set of musical notes and concomitant information sufficient to specify the musical score and enable its reproduction by suitable hardware. The process 208 comprises a processor trained with machine learning techniques to recognize the music score digital data 206, 210 and produce appropriate transformed data. The process 208 can be trained, for example, using neural network software engineering techniques to increase the accuracy of the interpretation process up to substantially 100% accuracy. In accordance with the present invention, the incoming music score data must be produced for audio and visual presentation to the user in real time, and therefore interpretation of the incoming music score data must be in real time and must approach 100% accuracy of interpretation (transformation). The process 208 utilizes optical character recognition (OCR) techniques, but is adapted for music note recognition and interpretation of digital data (electronic or optical scan derived) to an appropriate representation.

The interpretation process output 212 comprises a visual presentation of the music score, which is provided to a display screen 214 of the device, and also a synthesized audio rendition of the music score, which is provided to appropriate device systems and hardware 216 for audio presentation through loudspeakers of the device, or the like.

eMuse2

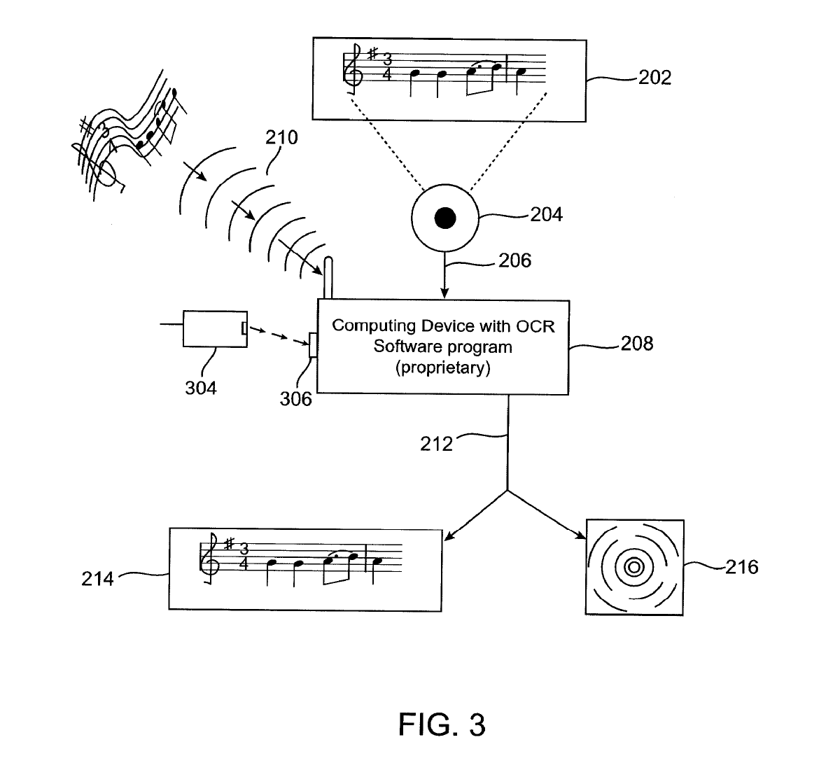

FIG. 3 is a process flow diagram that illustrates operation of the eMuse2 embodiment. The operations depicted in FIG. 2 are similar to the operations depicted in FIG. 3, and like operations are given like reference numerals. Thus, in FIG. 3, a digital representation of a music score is provided to the eMuse1 device either by visual presentation 202 and image capture 204 followed by presentation 206 to the note data interpretation process 208, or electronic receipt and presentation 210 to the process 208. The eMuse2 embodiment adds another alternative means of music score presentation, that of using a music card interface comprising a memory store 304 that mates with a reader or slot 306. The memory store 304 can comprise, for example, digital media such as Secure Digital (SD) cards, CompactFlash cards, MemoryStick media, and the like, while the reader 306 will comprise a suitable card reader to accept the data stored on the card 304. The music score data is then presented to the display 214 and audio reproduction 216 devices for playback.

eMuseX

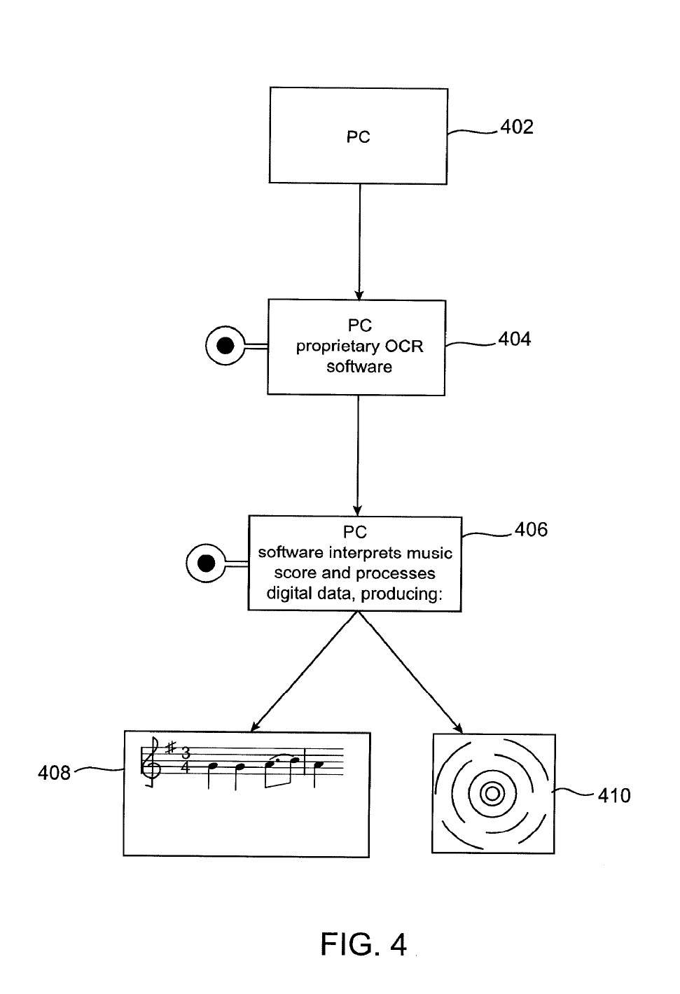

FIG. 4 is a process flow diagram that illustrates operation of the eMuseX embodiment. The eMuseX embodiment comprises a software package that can be installed in a host computing device, such as a desktop or laptop computer, a PDA device, or a “smart phone”. In the first operation 402, a host computer with the eMuseX software installed is activated to begin executing the eMuseX software. It should be understood that the host computer is also installed with software that implements the note data interpretation process 208 described previously and also includes a suitable image capture combination or a suitable electronic data receiving combination. The image capture combination can comprise a digital camera with an interface to the host computer, and the electronic data receiving combination can comprise wireless communication interface, a hard wired network communication interface, or a recorded data interface such as a memory card reader or a magnetic disk or optical disc (e.g., CD or DVD) drive.

In the next operation 404, the music score digital representation is provided to the note data interpretation process of the host computer, either by operation of the image capture combination or by operation of the electronic data receiving combination. The interpreted musical score data is provided to the host computer for processing and presentation 406, such that a display presentation 408 and an audio reproduction presentation 410 are generated by systems of the host computer for presentation to the user. The audio presentation 410 and display presentation 408 will generally correspond to the respective audio presentation 216 and display presentation 214 of the dedicated devices (FIG. 2 and FIG. 3), but might differ in details because of the different resources available to the host computer as compared to the dedicated devices.

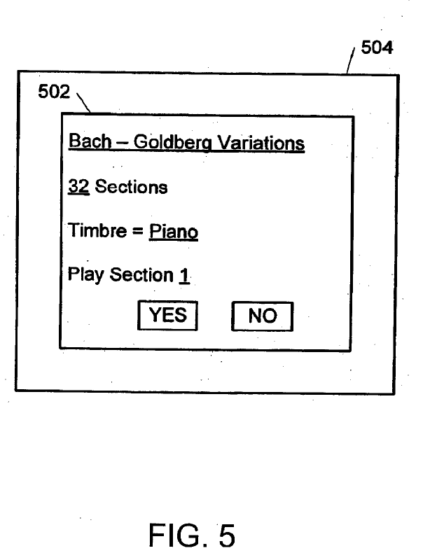

FIG. 5 illustrates a display screen that is produced by a device that incorporates the processing described herein, such as a handheld device or a host computer in which the application software is installed, to provide playback of a synthesized audio rendition. The device first receives music score data, such as by receiving a programmed music card into a music card reader of the device, or by receiving the information from a network interface, through either wireless or cable connection. The music score data can include, for example, the music score, and also musical contextual information that determines musical characteristics of the synthesized audio rendition of the music score. After the operating software of the device reads the music score data, the device displays a menu screen to provide the user with information about the music score and to request instruction from the user as to playback.

FIG. 5 shows a music score menu screen 502 as displayed on the display 504 of a handheld device (FIG. 1) or in a program window on the display of a host computer with the eMuse application software installed (FIG. 4). The menu screen shows the contents of the music score, in the FIG. 5 example, the music score is shown as “Bach-Goldberg Variations”. The menu 502 also shows the number of sections (e.g. tracks) in the music score, indicated in the FIG. 5 example as being thirty-two. The menu also shows the timbre, in FIG. 5 this is shown as being “piano”. Lastly, the menu asks the user for the section (or track) number at which playback will start. A default value (such as section 1) may appear in a display box 506 on the initial menu screen 502. The user can indicate that playback should start at the indicated position, Section 1, such as by selecting a “yes” or “play” command on a handheld device or by selecting “enter” or “yes” on the menu screen. In response, the device will begin playback of the synthesized audio rendition and will display the music score (music notes) on the display 504 in synchronization with the audio rendition. Alternatively, the user can enter a different section number in the input box 506 and then select “yes” or “play” or “enter”, and then the device will start to play the music score at the indicated section.

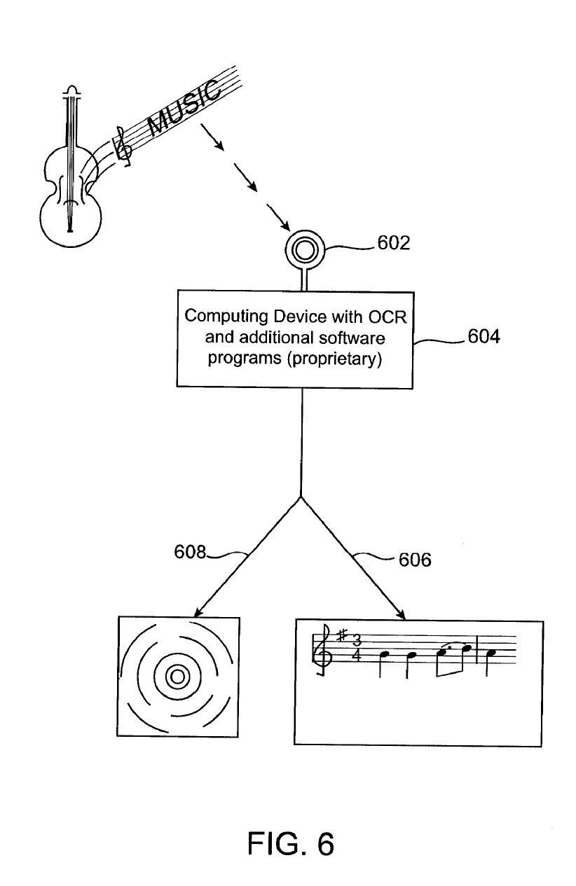

FIG. 6 is a process flow diagram that illustrates operation to provide a “music dictation” feature. This feature can be provided with handheld embodiments and host computer embodiments of the invention. In an initial operation 602, a microphone records a users performance of live music and a corresponding set of live note data is produced. The microphone output is recorded in digital format to produce the live note data, or is processed after recording to produce the live note data, comprising digital data that corresponds to the notes in the audio track of the user's performance. That is, the live note data is analogous to the music score data described elsewhere in this document. The live note data derived from the microphone 602 is then provided to a note data interpretation process 604. The interpretation process of the device processes the live note data to produce a visual display of the corresponding music score 606, and the device also produces an audio playback of the user's performance 608. In this way, the user's audio performance and the visual music notes that correspond to the user's audio performance are provided in a synchronized playback. In an additional feature, if the user performed a known recorded work that is available in a music score format, then the playback of the user's performance can be coordinated and compared with a synthesized audio/visual rendition of a music score of the recorded work.

Additional Functionality

Multiple simultaneous timbres (instruments) can be read and played, leading to possible usage as an enabler of “music minus one”
Multiple simultaneous volume controls would allow the user to minimize the volume of a specified instrumental or vocal line(s) of a multi-staff piece (“music minus one-half”) while keeping the other line(s) at a higher volume
A turn-page feature that combines the least measure(s) on one page with the first measure(s) on the next page into one “frame” would be incorporated into the device.
A metronome is incorporated into the device
A tuner is incorporated into the device
The device is able to transpose musical passages into any key.
The device displays the names of the notes of a musical passage (both English and solfege) on the LCD as that passage is being played
The OCR module retains the memory of a musical passage until the next passage is “photographed” so that a particular passage can be heard repeatedly without “photographing” it again.
Communications—facility for communications with eMuse music download servers, with both wired conductivity and wireless, such as WiFi, Bluetooth, and/or other telecom connections.
   Design Features

Buttons and Dials, Ports and Jacks

The following design features are provided (see FIG. 1).
Shutter botton 114—for initiating image capture and “photographing” a musical passage
Play button 126—for playing the “photographed” measures, a selection from a “music card,” and/or playback of a user's recorded performance.
Record button 132—to record a user's performance.
Primary volume wheel 116—to alter the volume of playback
Slot 106—to receive music card; possibly USB port
Headphone jack; line output 134
Numeric keypad 150—to respond to prompts on the LCD regarding selection of musical piece, movement, and/or measure numbers.
Speed wheel 118 (tempo)—to alter the playback speed of a passage (faster or slower)
Metronome 142—could use numeric keypad to select tempo of a playback passage, as well as the conventional use of a metronome.
Tuner 144—could use numeric keypad to specify frequency for tuning—e.g., Ab 440 or A442.

If desired, one or more of these buttons and dials can be combined in a simple +/− toggle.

Construction

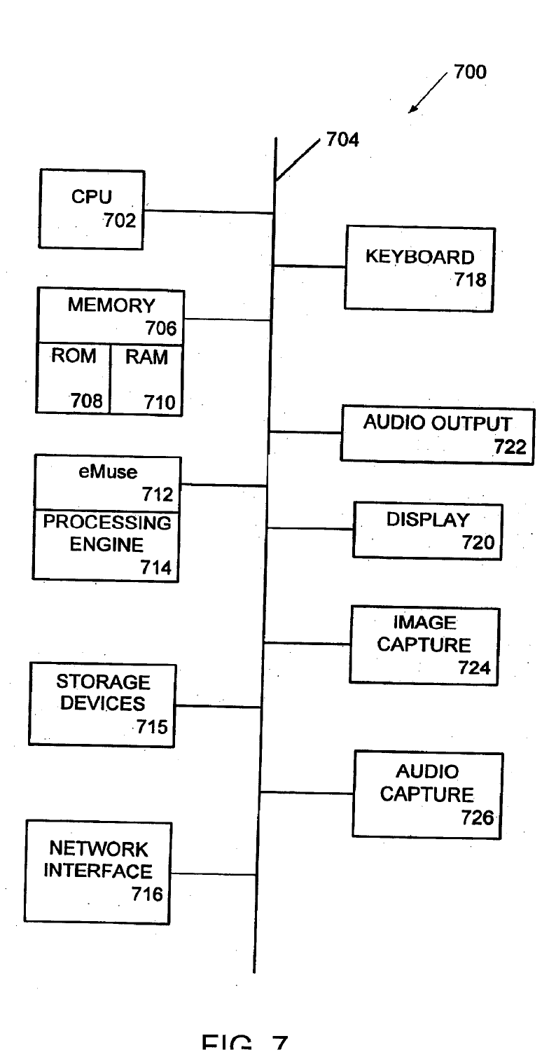

FIG. 7 is a block diagram of an embodiment of a music score capture and interpretation device 700 with audio-visual presentation, constructed in accordance with the invention. A control processor 702, such as a computer central processor unit (CPU), controls operations within the device 700. The CPU 702 communicates with other components, including data and commands, over a device bus or systems communication bus 704.

Commands and data are stored in memory 706, which can include program memory or ROM 708 and data memory or RAM 710. The memory 706 can be a mixture of volatile and non-volatile memory. The CPU executes commands and program instructions stored in program memory 708 to provide the features described herein. Operational data, such as music score data and the like, are stored in the data memory 710. Other data can be stored or received from storage devices 715 such as fixed storage devices (such as hard disk drives), storage drives for removable media (magnetic floppy disks, optical discs), and removable data cards (such as flash cards and similar media). Thus, the eMuse processing 712, including the note interpretation processing engine 714, shown as a separate component in FIG. 7, can be provided by a combination of program instructions and data stored in the memory 704 and executed by the CPU 702. The device 700 includes a network interface 716 for communication with other computers over a network. The network interface can provide for communication via a wireless link (such as WiFi or Bluetooth connections) or a wired (cable) connection (such as network cable or USB connections).

The device 700 also includes a keyboard 718, for receiving user inputs and commands, and includes a display 720, for presentation of data to the user. The display can comprise a display screen of a handheld device constructed in accordance with the invention, or can comprise a display of a host computer in which an application software embodiment of the invention is installed. The device also includes audio output 722, such as loudspeakers that can produce the audio rendition of a music score. The audio output facility 722 can also include headphone connections for private listening or other line out connections.

The device 700 also includes an image capture facility 724, such as an integrated digital camera system having a lens and shutter control button. The image capture facility can be an externally connected system, such as where a digital camera might be connected to a host computer via a network connection such as a USB port or wireless Bluetooth link. The device also includes an audio capture facility 726, such as a microphone connected to the device.

Examples of Usage

Following are scenarios of device usage, which illustrate how embodiments of the invention can be put to use.
A) Johnny (age 11) is having a bit of trouble in measure 18 of the Prelude of the first Bach cello suite. He picks up eMuse, turns it on, points it at measures 17-19 (which he observes through the LCD monitor), presses the little trigger, selects “cello” timbre, presses “play,” and listens to the playback on the device of mm.17-19. At the same time, he looks at the LCD to observe musical score and the cursor going by. Johnny wants to hear the passage again, but this time a bit slower, so he adjusts the tempo accordingly and presses “play” again. Satisfied that he understands the passage, he decides to try to play it himself, but wants also to compare it to what he just heard. So he presses “record” and plays the passage on his cello. Just to check it again, he listens to the playback of his performance.
He could also listen to a larger area of the piece—say mm.1-20, or indeed the entire piece—without finding a CD by simply inserting the “music-card” of this work. He would then hear it wherever he specifies, and could follow the courser along with the notes on the LCD.
He could also check the tuning of his cello with the built-in tuner, and his rhythmic accuracy and/or speed with the built-in metronome.
B) Samantha (age 16) is teaching herself to play guitar. Quite talented, she wants to play around with improvising solos around a set rhythm. She has a few music books that have the rhythmic sections of some of her favorite songs specified, and so she picks up eMuse, scans in the rhythm of an 8-bar section, selects “percussion” as the requested timbre, and plays back the sound through her home computer speakers using the line output of the device. As she hears the rhythms several times, she begins to improvise around them, each time doing something a bit different.
C) Mr. Hammer (age 58) has always wanted to learn the piano and finally decides to take some lessons. He has a particular love of Chopin Nocturnes, but in his own practicing he can't quite play the penultimate measure of Nocturne Op.27 no.2 with the group of 6 notes in the left hand played against the group of 7 notes in the right hand. He downloads the “music-card” for this Nocturne on his PC upstairs, then transmits this “file” to his eMuse, which is down in the living room on his piano bench. Since the file contains the fact that this is a piano work, the default timbre is “piano.” He specifies m.75 on the keypad, and thus goes right for the specific measure in question. He listens to it several times while remaining seated at his piano, trying it himself between playbacks, and then backs up the starting point to m.60 in order to hear the entire last page (Schirmer edition, Mikuli, editor).
D) Julie (age 15) has been studying piano for 7 years. She is having a bit of trouble with the changing meters in the beginning of the last movement of the Bartok Piano Sonata. She'd downloaded a “music card” of this piece several weeks ago since she's been working on it for some time. She inserts the “music card,” picks up eMuse, and “photographs” mm.20-24 of the last movement. She then presses the “play” button, and the device plays back those measures by matching the OCR information with that encoded in the music card. She listens to these four measures several times—slower then gradually faster. She then decides to hear the entire opening section (mm.1-27) so she specifies this on the keypad. There is no need for her to “photograph” anything again; the data now is read directly from the music card.
E) Alex (age 13) has played clarinet in the Junior High School band a couple of years. His band director is rehearsing the group in a Sousa March for the Memorial Day Parade, and since the clarinet section frequently rushes the tempo, he bought 4 music cards of this March for those students. When it was time to practice after dinner, Alex realized that he'd forgotten his music card at school, so he went to the PML site and downloaded another one onto his home PC. He transmitted this one (wireless) to his eMuse, plugged in headphones, “photographed” mm.14-16 at the end of the second phrase (one of the hard parts for him), and selected “clarinet” timbre. eMuse matched the OCR info of mm.14-16 the clarinet part with the music card info of the same measures, and when Alex pressed play, he heard the entire band playing those measures. To help him, only the clarinet part was displayed (with cursor) on the LCD, so he could follow his part while listening to the entire ensemble.
F) Janey (age 9) has just started to play violin. She is having a bit of trouble with the notes and rhythm of the second piece in that book (her assignment for that week), but her parents have bought her (retail) a “music-card” of a popular method book. She inserts the music-card (which automatically defaults to “violin” timbre since the method book is for that instrument, specifies the second piece on the keypad following the prompts on the LCD, presses play, and listens to the piece and watches the LCD as the cursor guides her along with the notes. She wants to hear mm.5-8 again, so she specifies those measures with the keypad after the LCD prompt asks about hearing anything again.
G) Jon, a student at NYU, is learning songs from West Side Story for a college production. Although he is an accomplished baritone, he still finds working with an accompanist—even between official rehearsals—to be very helpful. However, as a college student, his budget is quite limited and therefore cannot pay his accompanist to help him as frequently as he would like.
Having received eMuse as a birthday present, Jon purchases the music card for West Side Story, inserts it into the device, advances the position wheel to the song with which he wants to start, specifies “piano part only” from the “music minus one” heading that he dials in from the menu wheel. He then dials in “wireless to stereo” from the menu wheel, thus sending the audio signal to his stereo system via eMuse's wireless capability, and sings along with the piano part of the any song he wants to practice. He can look at either his own music, or the LCD of eMuse to follow the cursor. He can vary the tempo without changing pitch, and go over any song as many times as he wants. eMuse becomes his accompanist.
   Product Operation

Summary of Operation for the Handheld Device with Music Card Reader

The user inserts a music card into the product's music card slot, selects a music piece, selects timbres, selects a tempo, selects a location in the piece (the “passage marker”), and pushes the play button. The stop button stops the music. The play button starts play of the passage, at the beginning or taking it up again where it left off in a previous session (the “play location marker”), unless the user presses the back arrow button, in which case the play location marker moves back to the passage marker.

With the exceptions of volume and either tempo or the location of the passage marker, all selections are made by a single wheel/button or knob/button combination (in FIG. 1, the “menu wheel” 120 and the “next button” 130). This reduces both costs and intimidation of the user, and it allows new choices to be added without changing the hardware. The screen displays a list, the “menu” wheel or knob moves a cursor or text highlight through the list, and the “next” button selects the indicated choice. Default timbre and tempo selections are embedded in the file, so that in most cases the user simply steps through these to get things going.

Once operation is proceeding after initiation, the menu wheel 120 changes roles and always controls either tempo or the location of the passage marker. If it controls tempo, then volume and the passage marker have separate wheels; if it controls the passage marker, then volume and tempo have separate wheels. There are two reasons for having three separate wheels:
The user may want to change tempo, volume, or the location of the passage marker after play has begun. Separate wheels make this easy.
The volume control may be an analog potentiometer.

Details

On/Off

The unit powers up when the user depresses the on/off button. It may also power up when a flash drive is inserted. It shuts off when the flash drive is removed or after a selected period of inactivity, or when the user depresses the on/off button again.

Menu Sequence

Upon application of power, the unit enters the menu sequence. This is a series of choices that the user must make before play can begin. It appears as a sequence of lists (usually just two). The user can scroll through each list with the menu wheel. The next button registers the highlighted choice and moves to the next step.

The sequence of lists is dynamic, but may contain the following:
1. a list of pieces or movements on the flash drive, unless there is only one. (Usually, there will be more than one.)
2. the timbre (or timbres) to perform each voice. Usually, there will be just one, even for keyboard music. Default timbres will be embedded in the files.

As the lists are presented, the screen appears as follows:
across the top: a header naming the choice
down one side: the list, with one member highlighted
on the other side: concise instructions to the effect that the user should use the wheel to select one item, then press the next button.

These instructions may take the form of labels for the wheel and button.

After the last selection has been made, the unit advances to play mode.

Play

When the unit is in play mode, the screen displays music notation (with one or more location markers) in the middle, and the current metronome marking, probably near its adjustment wheel.

Music Notation

Music notation is presented on the display screen in accordance with the physical size of the screen; generally sufficient size is available to show a single staff or system of staves.

Positioning

The product keeps track of two places in the music: the point selected by the user as the beginning of a passage to play (the “passage marker”), and the point that is currently being played (the “play location marker”). The passage marker is noted by the device to indicate, for example, a measure that is being played. The play location marker is described herein as the cursor. Preferably, the user can choose to show the play location marker (cursor) only, since the back arrow button moves the play location marker to the passage marker location, and since the position wheel moves both markers at once.

Generally, the play location marker will not change appearance during playback. Notes on the display will change color or brightness when they are sounding during playback.

Controls affecting positioning are the passage marker wheel, the play button, and the back arrow button. The two buttons move the play location marker without affecting the passage marker; the wheel moves both markers.

Tempo

When the unit enters play mode, the default tempo appears on the screen near its wheel in the form of a metronome marking 142. The tempo can be changed at any time.

Product Controls

Reset Button 130

Restarts the operational sequence, as if power had just been applied. The display shows the list of pieces on the music card drive.

Next Button 130

Selects the highlighted item from the list controlled by the menu wheel and moves to the next step. Once the menu sequence completes, the next button becomes ineffective. Until the reset button is pushed or power is cycled, the menu wheel continues to control tempo, and any changes are reflected immediately.

Menu Wheel

File selection

See “Menu sequence”, above.

Timbre selection

See “Menu sequence”, above.

Tempo Wheel 118

The tempo wheel 118 controls the playback tempo of the music passage.

Passage Marker Wheel

Control of the passage marker is through the menu wheel. Preferred operation of the menu wheel in Passage Marker mode is as follows:

If the unit is playing when the wheel is moved, the unit stops.
Moving the wheel will move both the passage marker and the play location marker, starting at the position of the play location marker.
The relationship between the speed of the wheel and the speed of marker movement will be nonlinear. Moving the wheel slowly will move the marker slowly, but doubling the speed of the wheel will more than double the speed of the marker. A meta control will adjust the second derivative of the curve so that we can experiment, but that may not be enough. It is likely that the second derivative should itself be a function of the length of the piece. The user should be able to move halfway through a long piece without turning the wheel all day. At the same time, a rapid movement should not throw him off the edge of the world if he is working with a short piece.

Volume Wheel

Control of the playback volume is through the volume wheel.

Play Button 126

Commences play at the play location marker and moves the marker.

Stop Button 128

Stops play. Leaves the play location marker where it is.

Back Arrow Button (Move to Beginning of Passage)

Stops play, if appropriate, and moves the play location marker to the passage marker.

Meta Controls

Screen

The size and shape of the screen can be set at runtime by resizing the window on which it and the emulated product controls appear. Meta controls may be added to set limits to resolution, brightness, and contrast.

Files

The device operates on standard MusicXML files, and also can process condensed or compressed forms of those files.

Music Card Flash Drive

The flash drive interface 106 accepts memory cards in various formats. In other words, a meta control is used to select a directory containing MusicXML files. The device then displays those files at the beginning of each menu sequence. If the directory representing the flash drive contains subdirectories, they are not displayed. If a real flash drive is inserted into the machine, it can be selected.

The present invention has been described above in terms of a presently preferred embodiment so that an understanding of the present invention can be conveyed. There are, however, many configurations for music score capture and presentation systems not specifically described herein but with which the present invention is applicable. The present invention should therefore not be seen as limited to the particular embodiments described herein, but rather, it should be understood that the present invention has wide applicability with respect to music score capture and presentation generally. All modifications, variations, or equivalent arrangements and implementations that are within the scope of the attached claims should therefore be considered within the scope of the invention.

1. A method of processing a printed music score for solo instrument, multiple instruments, voice or multiple voices, or any combination thereof, by a computing device, the method consisting of:
receiving the music score at the computing device from an external source;
interpreting the music score and converting it to a digitized form;
processing the resulting data so as to produce a synthesized audio rendition of the music score, including synthesized vocal rendition matching word with appropriate pitch, that is synchronized with a visual presentation of the score.

2. A method as defined in claim 1, wherein the external source consists of a network data source, which provides the music score data to the computing device over a network connection.

3. A method as defined in claim 2, wherein the network connection consists of a communication between the computing device and the network over a wireless connection.

4. A method as defined in claim 1, wherein receiving the music score data consists of reading the music score data from a recorded medium.

5. A method as defined in claim 4, wherein reading the music score data consists of accepting the recorded medium in a reader of the computing device and obtaining the music score data from the recorded medium.

6. A method as defined in claim 5, wherein the recorded medium contains sufficient data for audio playback in accordance with a musical instrument digital interface (MIDI) specification for synthesized audio music production.

7. A method as defined in claim 1, further consisting of:
recording a user performance of the musical notes; and
providing audio playback of the recorded user performance with visual presentation of the recorded user performance synchronized with the audio playback.

8. A method as defined in claim 1, wherein receiving the music score data consists of optically photographing a music score and generating digital image data that corresponds to the music score.

9. A method as defined in claim 1, wherein the computing device identifies musical contextual information that determines characteristics of the synthesized audio playback of the music score data, all of which may be adjusted by the user.

10. A method as defined in claim 9, wherein the musical contextual information includes clef, key signature, time signatures, timbre, tempo and expressive terms such as legato, crescendo, ritard, etc.

11. A method as defined in claim 1, wherein producing an audio playback of the music score data and a visual presentation of musical notes is effected through communication with a network data source.

12. A method as defined in claim 11, wherein the network data source provides the music score data to the computing device.

13. A method as defined in claim 1, wherein producing a synthesized audio rendition of the music score data and a visual presentation of music score is effected by means of a recorded medium inserted into a reader incorporated into the computing device.

14. A method as defined in claim 13, wherein the recorded medium provides musical contextual information for determining the characteristics of the synthesized audio rendition of the music score data, all of which may be adjusted by the user.

15. A method as defined in claim 1, wherein the audio playback is produced by the computing device in accordance with a musical instrument digital interface (MIDI) specification.

16. A method as defined in claim 1, wherein producing the visual presentation consists of displaying notes of a music score in a manner that is synchronized with the synthesized audio rendition of those notes.

17. A method as defined in claim 1, further consisting of providing simultaneous playback of the music score data and the recorded user performance.

18. A method as defined in claim 1, further comprising deletion of a musical part from the music score.

19. A method as defined in claim 18, wherein the user selects the deleted musical part.

20. A method of processing music score data by a computing device, the method comprising:
digitally photographing a music score and generating the music score data for the computing device that corresponds to such score; and
producing a synthesized audio rendition of the music score data and a visual presentation of the corresponding notes.

21. A method as defined in claim 20, further consisting of receiving musical contextual information for determining the characteristics of the synthesized audio rendition of the music score data, all of which may be adjusted by the user.

22. A method as defined in claim 21, wherein the musical contextual information includes clef, key signature, time signatures, timbre, tempo and expressive terms including one or more from the group including legato, crescendo, ritard.

23. A method as defined in claim 21, wherein the computing device identifies the musical contextual information from the digitally photographed music score.

24. A method as defined in claim 21, wherein the computing device obtains the musical contextual information from a network data source.

25. A method as defined in claim 20, wherein producing a synthesized audio rendition of the music score data and a synchronized visual presentation of the music score is effected through communication with a network data source.

26. A method as defined in claim 25, wherein producing a synthesized audio rendition of the music score data and a synchronized visual presentation of the music score is effected by means of a recorded medium inserted into a reader incorporated into the computing device.

27. A method as defined in claim 25, further consisting of:
recording a user performance of the musical notes; and
providing playback of the recorded user performance with visual presentation of the recorded user performance synchronized with the audio playback.

28. A method as defined in claim 20, further comprising deletion of a musical part from the music score.

29. A method as defined in claim 28, wherein the user selects the deleted musical part.

30. A computing device comprising:
a display screen;
an integrated audio synthesizer module;
network interface through which the computing device communicates with a network; and
a computer processor that receives music score data from an external source and produces a synthesized audio rendition of the music score data through the audio module and produces a synchronized visual presentation on the display screen of the music score.

31. A computing device as defined in claim 30, wherein the computer processor receives image information from an image capture unit that captures an optical image of a music score, wherein the computer microprocessor processes the image information to produce the music score data.

32. A computing device as defined in claim 31, wherein the computing device records the captured optical image in memory of the computing device.

33. A computing device as defined in claim 30, wherein the computing device receives musical contextual information that determines the characteristics of the synthesizes audio rendition of the music score data, all of which may be adjusted by the user.

34. A computing device as defined in claim 33, wherein the computing device identifies the musical contextual information from the digitally photographed music score.

35. A computing device as defined in claim 33, wherein the musical contextual information includes clef, key signature, time signatures, timbre, tempo and expressive terms including one or more from the croup including legato, crescendo, ritard.

36. A computing device as defined in claim 33, wherein the computing device receives the musical context information from a recorded medium.

37. A computing device as defined in claim 30, wherein the computer processor produces a synthesized audio rendition of the music score data and a synchronized visual presentation of the music score through communication with a network data source.

38. A computing device as defined in claim 30, wherein the computer processor produces a synthesized audio rendition of the music score data and a synchronized visual presentation of the music score by means of a recorded medium inserted into a reader incorporated into the computing device.

39. A computing device as defined in claim 38, wherein the recorded medium contains sufficient data for audio playback of data stored therein in accordance with a musical instrument digital interface (MIDI) specification for synthesized audio rendition.

40. A computing device as defined in claim 30, further including a record and playback module that records a user performance of the musical notes and provides playback of the recorded user performance with visual presentation of the recorded user performance synchronized with the audio playback.

41. A computing device as defined in claim 30, wherein the display screen, audio synthesizer module, digital imaging capturing device, user controls and computer microprocessor are placed within a portable handheld housing equipped for battery and/or AC operation.

42. A computing device as defined in claim 30, wherein the display screen consists of a flat panel display on which the user can view a graphic representation of the music score and notes and on which the note or notes being synthesized at any given time are highlighted by a unique color, cursor or similar means.

43. A computing device as defined in claim 30, further comprising deletion of a musical part from the music score.

44. A computing device as defined in claim 30, wherein user selects the deleted musical part.

45. A program product consisting of:
a program media that is readable by a computing device; and
programming instructions recorded to the program media such that the programming instructions are read by the computing device and executed to perform a method comprising operations of receiving the music score data at the computing device from an external source and producing a synthesized audio rendition of the music score data and a synchronized visual presentation of the music score.

46. A program product as defined in claim 45, wherein the computing device receives the music score data from an external source consisting of a network data source that provides the music score data to the computing device by means of a network connection.

47. A program product as defined in claim 45, wherein the computing device executes the programming instructions to identify musical contextual information that determines the characteristics of the synthesizes audio rendition of the music score data, all of which may be adjusted by the user.

48. A program product as defined in claim 47, wherein the computing device executes the programming instructions to process musical context information that includes further consisting of receiving musical contextual for determining the characteristics of the synthesized audio rendition of the music score data.

49. A program product as defined in claim 45, wherein the computing device produces a synthesized audio rendition of the music score data and a synchronized visual presentation of the music score through communication with a network data source.

50. A program product as defined in claim 45, wherein the computing device produces a synthesized audio rendition of the music score data and a synchronized visual presentation of the music score by means of a recorded medium inserted into a reader incorporated into the computing device.

51. A program product as defined in claim 45, wherein the computing device executes the programming instructions to produce the synthesized audio rendition in accordance with a musical instrument digital interface (MIDI) specification for synthesized music production.

52. A program product as defined in claim 45, wherein the computing device produces the visual presentation consisting of displaying notes of a music score in a manner that is synchronized with the synthesized audio rendition of those notes

53. A program product as defined in claim 45, further comprising providing simultaneous playback of the music score data and the recorded user performance with visual presentation of the recorded user performance synchronized with the audio playback.

54. A program product as defined in claim 45, further comprising deletion of a musical part from the music score.

55. A program product as defined in claim 54, wherein the user selects the deleted musical part.
